(19) United States
(12) Patent Application Publication
(10) Pub. No.: US 2025/0097008 A1
(43) Pub. Date: Mar. 20, 2025

(54) 3D DATA GENERATION DEVICE, ANALYSIS SERVER, AND 3D PRINTING METHOD EMPLOYING HOMOMORPHIC ENCRYPTION

(71) Applicant: Electronics and Telecommunications Research Institute, Daejeon (KR)

(72) Inventors: Kyu Sung LEE, Daejeon (KR); Seong Cheon PARK, Daejeon (KR); Shin Yuk KANG, Daejeon (KR); Hyun Woo KIM, Daejeon (KR); Su Yeon JANG, Daejeon (KR)

(73) Assignee: Electronics and Telecommunications Research Institute, Daejeon (KR)

(21) Appl. No.: 18/949,266

(22) Filed: Nov. 15, 2024

(30) Foreign Application Priority Data
Sep. 19, 2023 (KR) 10-2023-0125037

(51) Int. Cl. H04L 9/00; B29C 64/393; B33Y 50/02; H04L 9/08

(52) U.S. Cl. CPC H04L 9/008; B29C 64/393; B33Y 50/02; H04L 9/0825; H04L 2209/08

(57) ABSTRACT

Provided are a three-dimensional (3D) data generation device, an analysis server, and a 3D printing method employing a homomorphic encryption scheme. The 3D data generation device includes a memory, a scan module, and a processor connected to the memory and the scan module. The processor generates 3D data of an object scanned through the scan module and encrypts the 3D data in accordance with a homomorphic encryption scheme.

### CROSS-REFERENCE TO RELATED APPLICATION

This application claims priority to and the benefit of Korean Patent Application No. 10-2023-0125037, filed on Sep. 19, 2023, the disclosure of which is incorporated herein by reference in its entirety.

### BACKGROUND

### 1. Field of the Invention

The present invention relates to a three-dimensional (3D) data generation device, an analysis server, and a method for 3D printing of 3D data to which homomorphic encryption is applied.

### 2. Discussion of Related Art

Currently, according to three-dimensional (3D) printing technology, shapes are created through several printing processes from data that is designed or scanned using position and height information based on coordinate values (geometry (G)-code) determined by 3D modeling. 3D printing processes are performed and utilized in specialized application fields, such as color 3D printing, bio 3D printing, and the like, using some unique forms of materials and processes. In the case of medical/bio 3D printing, common application fields include dentistry, surgical instruments, regeneration and rehabilitation, artificial organs, and the like.

Therefore, in the case of utilizing current personal 3D body shape data, it is difficult to apply a data processing measure for protecting sensitive personal information. In addition, it is currently difficult to collect data within a cloud environment and utilize a data optimization process based on artificial intelligence (AI) or machine learning.

### SUMMARY OF THE INVENTION

The present invention is directed to providing a three-dimensional (3D) data generation device, an analysis server, and a method for 3D printing employing homomorphic encryption, which lead to an improvement in the security and reliability of data when a 3D printing structure is manufactured using personal data, security data, or the like with a high degree of sensitivity.

According to an aspect of the present invention, there is provided a 3D data generation device including a memory, a scan module, and a processor connected to the memory and the scan module. The processor generates 3D data of an object scanned through the scan module and encrypts the 3D data in accordance with a homomorphic encryption scheme.

The processor may generate a first encryption key and encrypt the 3D data in accordance with an algorithm defined in the homomorphic encryption scheme using the first encryption key.

The processor may slice the 3D data into a plurality of layers and encrypt coordinate data of each layer with respect to a reference axis using the homomorphic encryption scheme.

The 3D data generation device may further include an output module, and the processor may receive homomorphically encrypted result data from an analysis server, generate the 3D data and optimized 3D printing control information by decrypting the homomorphically encrypted result data, and three-dimensionally print the decrypted 3D data through the output module in accordance with the optimized 3D printing control information.

The processor may decrypt the homomorphically encrypted result data using a first encryption key used for encrypting the 3D data.

The processor may generate dummy pattern 3D data, encrypt the dummy pattern 3D data in accordance with the homomorphic encryption scheme using a second encryption key, and transmit the homomorphically encrypted dummy pattern 3D data together with the homomorphically encrypted 3D data to an analysis server.

When the homomorphically encrypted result data including the homomorphically encrypted 3D data, the homomorphically encrypted dummy pattern 3D data, and optimized 3D printing control information is received from the analysis server, the processor may decrypt the 3D data and the optimized 3D printing control information by decrypting the homomorphically encrypted result data using the first encryption key used for homomorphically encrypting the 3D data and decrypt the dummy pattern 3D data by decrypting the homomorphically encrypted dummy pattern 3D data using the second encryption key.

According to another aspect of the present invention, there is provided an analysis server including a server communication module, a server memory, and a server processor connected to the server communication module and the server memory. The server processor receives homomorphically encrypted 3D data from a 3D data generation device through the server communication module, acquires optimized 3D printing control information by performing homomorphic operation on the homomorphically encrypted 3D data, and generates homomorphically encrypted result data including the optimized 3D printing control information.

The server processor may select the optimized 3D printing control information including at least one of a 3D printing process method, a 3D printing material, a 3D printing material property, a 3D printing cost, and a 3D printing path on the basis of the homomorphically encrypted 3D data, perform simulation on the 3D data on the basis of the selected optimized 3D printing control information, and predict quality performance when the 3D data is applied to 3D printing.

The server processor may optimize the homomorphically encrypted 3D data and remove defective data during the homomorphic operation of the homomorphically encrypted 3D data.

The server processor may employ one or more hardware accelerators during the homomorphic operation of the homomorphically encrypted 3D data.

According to another aspect of the present invention, there is provided a 3D printing method employing homomorphic encryption, the 3D printing method including encrypting by a 3D data generation device, 3D data generated by scanning an object in accordance with a homomorphic encryption scheme and transmitting the homomorphically encrypted 3D data to an analysis server, performing, by the analysis server, a homomorphic operation on the homomorphically encrypted 3D data to acquire optimized 3D printing control information and transmitting homomorphically encrypted result data including the optimized 3D printing control information to a 3D printing device, and decrypting, by the 3D printing device, the homomorphically encrypted result data to generate the 3D data and the optimized 3D printing control information and three-dimensionally printing the decrypted 3D data on the basis of the optimized 3D printing control information.

The transmitting of the homomorphically encrypted 3D data to the analysis server may include generating, by the 3D data generation device, a first encryption key and encrypting the 3D data in accordance with an algorithm defined in the homomorphic encryption scheme using the first encryption key.

The transmitting of the homomorphically encrypted 3D data to the analysis server may include slicing, by the 3D data generation device, the 3D data into a plurality of layers and encrypting coordinate data of each layer with respect to a reference axis using the homomorphic encryption scheme.

The transmitting of the homomorphically encrypted result data to the analysis server may include selecting, by the analysis server, the optimized 3D printing control information including at least one of a 3D printing process method, a 3D printing material, a 3D printing material property, a 3D printing cost, and a 3D printing path on the basis of the homomorphically encrypted 3D data, and simulating the 3D data on the basis of the selected optimized 3D printing control information to predict quality performance when the 3D data is applied to 3D printing.

The transmitting of the homomorphically encrypted result data to the analysis server may include performing, by the analysis server, a homomorphic operation on the homomorphically encrypted 3D data to optimize the 3D data and remove defective data, and then acquiring the optimized 3D printing control information.

The 3D printing of the decrypted 3D data may include decrypting, by the 3D printing device, the homomorphically encrypted result data using a first encryption key used for encrypting the 3D data.

The transmitting of the homomorphically encrypted 3D data to the analysis server may include generating, by the 3D data generation device, dummy pattern 3D data, encrypting the dummy pattern 3D data in accordance with the homomorphic encryption scheme using a second encryption key, and transmitting the homomorphically encrypted dummy pattern 3D data together with the homomorphically encrypted 3D data to the analysis server.

The 3D printing of the decrypted 3D data may include, when the homomorphically encrypted result data includes the homomorphically encrypted 3D data, the homomorphically encrypted dummy pattern 3D data, and the optimized 3D printing control information, decrypting, by the 3D printing device, the homomorphically encrypted result data using the first encryption key used for homomorphically encrypting the 3D data to decrypt the 3D data and the optimized 3D printing control information and decrypting the homomorphically encrypted dummy pattern 3D data using the second encryption key to decrypt the dummy pattern 3D data.

The 3D printing of the decrypted 3D data may include removing, by the 3D printing device, the decrypted dummy pattern 3D data from the decrypted 3D data to regenerate the 3D data and three-dimensionally printing the regenerated 3D data on the basis of the optimized 3D printing control information.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is a block diagram of a three-dimensional (3D) printing system employing homomorphic encryption according to an exemplary embodiment of the present invention;

FIG. 2 is a schematic block diagram of a 3D data generation device according to an exemplary embodiment of the present invention;

FIG. 3 is an exemplary diagram illustrating a method of encrypting 3D data according to an exemplary embodiment of the present invention;

FIG. 4 is a schematic block diagram of an analysis server according to an exemplary embodiment of the present invention;

FIG. 5 is a sequence diagram illustrating a 3D printing method employing homomorphic encryption according to an exemplary embodiment of the present invention;

FIG. 6 is a sequence diagram illustrating a 3D printing method employing homomorphic encryption according to another exemplary embodiment of the present invention; and

FIG. 7 is a sequence diagram illustrating a 3D printing method employing homomorphic encryption according to still another exemplary embodiment of the present invention.

### DETAILED DESCRIPTION OF EXEMPLARY EMBODIMENTS

A three-dimensional (3D) data generation device, an analysis server, and a method for 3D printing employing homomorphic encryption according to exemplary embodiments of the present invention will be described below. In this process, the thicknesses of lines, the sizes of components, and the like shown in the drawings may be exaggerated for the purpose of clarity and convenience of description. In addition, terms to be described below are defined in consideration of functions in the present invention, and the terms may vary depending on the intention of a user or operator or precedents. Therefore, these terms are to be defined on the basis of the overall content of the specification.

Hereinafter, exemplary embodiments of the present invention will be described in detail with reference to the accompanying drawings such that those of ordinary skill in the art can readily implement the present invention. However, the present invention can be implemented in several different forms and is not limited to the embodiments described herein. To clearly describe the present invention, parts irrelevant to the description will be omitted from the drawings. Throughout the drawings, like reference numerals refer to like elements.

Throughout the specification, when a part is referred to as “including” any component, other components are not excluded but may further be included unless particularly stated otherwise.

The embodiments described herein may be implemented as, for example, a method, a process, a device, a software program, a data stream, or a signal. Even when an embodiment is discussed in a single form of implementation (e.g., only as a method), the discussed features may be realized in another form (e.g., as a device or program). The device may be implemented in a suitable form such as hardware, software, firmware, or the like. The method may be realized by a device, such as a processor or the like, which is generally referred to as a processing device including, for example, a computer, a microprocessor, an integrated circuit, a programmable logic device, or the like.

Fields in which medical/bio 3D printing is commonly utilized may be dentistry, surgical instruments, regeneration and rehabilitation, artificial organs, and the like.

In the field of dentistry, a 3D printing technique of three-dimensionally scanning and then light-curing a tooth shape has become mainstream, and dental 3D printing is increasingly used for prosthetic structures, clear braces, surgical guides for implants, laminates, denture fabrication, artificial teeth, and the like. After intraoral three-dimensional scanning of the shape of a tooth is performed in a dental clinic, 3D data is generated and reprocessed by a computer-aided design (CAD) program or the like to modify and supplement the design and shape to be more suitable to the application portion and then printed using a 3D printer. While some all-in-one processes may be performed in a clinic, 3D printing and postprocessing subsequent to intraoral scanning are performed by a specialized company in a majority of cases.

In the case of surgical assistance devices, surgical guides are increasingly being utilized in the medical field to obtain immediate assistance related to surgery. The aspects of immediate response and functionality with respect to surgical assistance devices are seen to be more important than design. However, a method, in which surgical assistance devices are made by a specialized 3D printing company and then processed in an operating room to be suitable for certain situations prior to surgery, is being chosen.

When 3D printing is utilized for auxiliary tools in the field of regeneration and rehabilitation, the purpose is to protect and treat wounds, and a personalized market therefor is continuing to grow. To offer certain health aid tools, by performing scanning for personal body information and subsequently 3D printing and postprocessing, production of a small variety is conducted in a make-to-order manner.

In the field of artificial organs, while 3D printing is still in a basic research stage due to limitations in terms of materials and the complexity of implementing functions, it is gradually approaching the realization of functions due to technological development.

As described above, a key feature of the application of 3D printing technology in the medical/bio sector is the creation of personalized 3D shapes or the creation of 3D shapes based on the acquisition of body information. Accordingly, to create a 3D structure, body shape information, which is sensitive personal information, should be shared or exposed. In the current process of utilizing and processing data related to personal body shapes, the necessity to protect information and process encrypted data is expected to increase.

Moreover, in the process of utilizing 3D shape data, it is necessary to process the original data of 3D scanning data at several stages. For example, there may be resolution issues at a scanning stage or the inclusion of errors at the scanning stage. A correction task is required in consideration of a difference from the actual shape of the original 3D data obtained through such a scan. When correlated to a 3D printing process, there are cases in which computational processing of 3D data is required depending on properties of materials and equipment with respect to which 3D printing is being performed and optimization of the printing path or data coordinates for printing, which determine the printing quality, is necessary. In recent years, by utilizing artificial intelligence (AI) for this optimization process, technology is being developed to improve quality and reduce time, and the demand for utilizing AI in the optimization process of 3D data is increasing.

Further, in the case that the process from the scanning and processing of 3D data utilizing biological shape information to utilization of the 3D data in 3D printing is performed in the same entity when data protection is well established within the entity, there may be few problems such as leakage of personal or sensitive information with adequate protection of data within the entity. However, when a data acquisition (scanning) entity, a data generation and optimization (data activation by AI or machine learning) entity, and a data utilization (printing) entity are different from one another, a system may be required for protecting sensitive information in the data transmission sharing process.

Therefore, exemplary embodiments of the present invention propose a technology for providing a user (individual or medical entity) who is an owner of sensitive biological shape data with the right to manage and use security-related encryption keys (a public key and a private key), obtaining optimized data through AI and machine learning using a cloud service or the like by applying a homomorphic encryption scheme to encrypted data in a form that allows computation and processing of 3D data, and utilizing the obtained optimized data to obtain higher quality 3D data and printed shape results.

Further, the present exemplary embodiments propose an AI-based 3D data processing optimization prediction system which uses encrypted data processing of sensitive personal information in the process of AI computation using 3D data based on personal body shape information and optimization for 3D printing and is required for connecting to a cloud service in the process thereof.

Further, the present exemplary embodiments relate to a technology for increasing data security when applying 3D printing technology to sensitive personal information, such as health/medical information, healthcare information, or the like or to classified data of the defense/security sector. The present exemplary embodiments relate to a technology for increasing security and reliability by applying a homomorphic encryption technology for processing or storing data when manufacturing a 3D printing structure by utilizing highly sensitive personal data and classified data or when combining and computing sensitive data and applying AI techniques utilized to optimize 3D printing results.

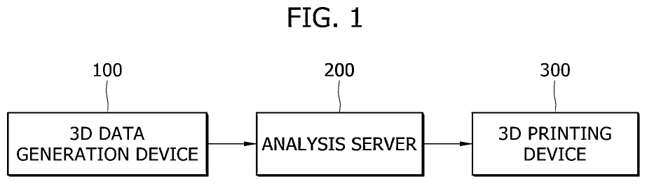

FIG. 1 is a block diagram of a 3D printing system employing homomorphic encryption according to an exemplary embodiment of the present invention.

Referring to FIG. 1, the 3D printing system employing homomorphic encryption according to an exemplary embodiment of the present invention includes a 3D data generation device 100, an analysis server 200, and a 3D printing device 300, which may be connected via a communication network.

The 3D data generation device 100 may encrypt 3D data, which is generated by scanning an object, using a homomorphic encryption scheme and transmit the homomorphically encrypted 3D data to the analysis server 200. At this time, the 3D data generation device 100 may generate a first encryption key and encrypt the 3D data using the first encryption key in accordance with an algorithm defined in the homomorphic encryption scheme. Meanwhile, the object may be related to highly-sensitive personal data (e.g., a personal body shape) such as in a health/medical field, a healthcare field, or the like, confidential data in advanced manufacturing industries, such as semiconductor, display, battery, sensor, automobile industries, and the like, or classified data requiring highly-reliable security such as in the space or defense industry. The first encryption key may include a public key and a private key. The homomorphic encryption scheme may be any of various schemes, such as a Brakerski-Gentry-Vaikuntanathan (BGV) scheme, a Brakerski-Fan-Vercauteren (BFV) scheme, a Cheon-Kim-Kim-Song (CKKS) scheme, and the like.

The homomorphic encryption technology is an encryption technique for performing a computation while the original data (e.g., a message or plaintext) is encrypted, in which a computation result of the original data and the computation result of the encrypted data (e.g., ciphertext) are the same. Due to this characteristic, the homomorphic encryption technology allows computations of encrypted data without decrypting the encrypted data. The homomorphic encryption technology may be useful for storing sensitive data that requires privacy protection in an encrypted state on an external medium or requesting that the external medium (e.g., a commercial cloud server) combine and compute the data in an encrypted state.

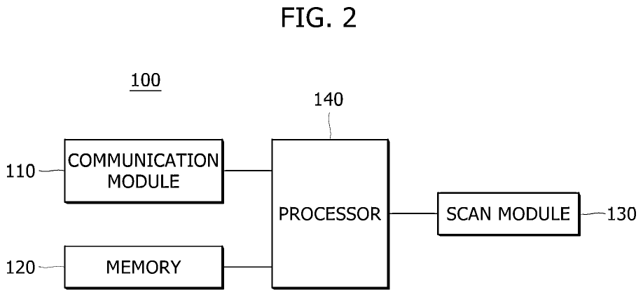

The 3D data generation device 100 will be described in detail below with reference to FIG. 2.

The analysis server 200 may receive the homomorphically encrypted 3D data from the 3D data generation device 100 and perform a homomorphic operation on the homomorphically encrypted 3D data to generate homomorphically encrypted result data including optimized 3D printing control information which is to be applied to 3D printing. Here, the optimized 3D printing control information may include a 3D printing process method, a 3D printing material, a 3D printing material property, a 3D printing cost, and a 3D printing path, and the like of the 3D data.

In other words, the analysis server 200 may optimize a 3D printing process method depending on an application field of the 3D data, optimize a 3D printing material in consideration of characteristics of the application field of the 3D data, determine a structure designed by applying the selected 3D printing material, optimize a 3D printing material property, optimize a 3D printing cost in consideration of the amount and cost of material to be used, and optimize a 3D printing path in consideration of an effect thereof on printing quality. In addition, the analysis server 200 may check the stability of the design and structure over a long term and perform comprehensive prediction and verification of performance.

The analysis server 200 may employ one or more hardware accelerators when performing the homomorphic operation of the homomorphically encrypted 3D data. In other words, the analysis server 200 may include a hardware accelerator with a function, which is frequently utilized in computations when 3D data is homomorphically encrypted, to increase computation speed. The analysis server 200 may simultaneously utilize several hardware accelerators to improve performance.

The analysis server 200 can ensure optimized quality by optimizing the 3D data using personal information or sensitive information in an external or cloud environment and applying the 3D data to 3D printing.

The analysis server 200 may also be referred to as a computing device or a cloud server.

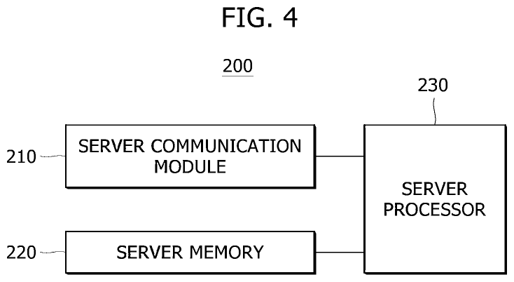

The analysis server 200 will be described in detail below with reference to FIG. 4.

The 3D printing device 300 may receive the homomorphically encrypted result data from the analysis server 200, decrypt the homomorphically encrypted result data to generate the 3D data and the optimized 3D printing control information, and three-dimensionally print the decrypted 3D data on the basis of the 3D printing control information. At this time, the 3D printing device 300 may decrypt the homomorphically encrypted result data using the first encryption key used for encrypting the 3D data.

The 3D printing device 300 may output the decrypted 3D data from the analysis server 200 in accordance with the optimized 3D printing control information (the 3D printing process method, the 3D printing material, the 3D printing material property, the 3D printing cost, and the 3D printing path) to output a 3D object in the same shape as or a complemented shape of the initially scanned object.

Meanwhile, a printer used by the 3D printing device 300 may be a 3D printer employing stereolithography (SLA), selective laser sintering (SLS), PolyJet, mask-projection image curing (digital light processing (DLP)), fused deposition modeling (FDM), or the like. In other words, according to the degree of realization of an object to be printed, the 3D printing device 300 may employ SLA, SLS, DLP, and the like for high quality or employ FDM, PolyJet, and the like for general quality.

According to another embodiment of the present invention, the 3D data generation device 100 may generate a first encryption key and a second encryption key, encrypt the 3D data in according with a homomorphic encryption scheme using the first encryption key, and encrypt dummy pattern 3D data in accordance with the homomorphic encryption scheme using the second encryption key.

The 3D data generation device 100 may transmit the homomorphically encrypted 3D data and the homomorphically encrypted dummy pattern 3D data to the analysis server 200.

When the homomorphically encrypted result data including the homomorphically encrypted 3D data, the homomorphically encrypted dummy pattern 3D data, and the optimized 3D printing control information is received from the analysis server 200, the 3D data printing device 300 may decrypt the homomorphically encrypted result data using the first encryption key, which has been used to homomorphically encrypt the 3D data, to generate the 3D data and the 3D printing control information. The 3D printing device 300 may three-dimensionally print the decrypted 3D data on the basis of the optimized 3D printing control information. At this time, the homomorphically encrypted dummy pattern 3D data may not be in a decrypted state.

Moreover, the 3D printing device 300 may decrypt the homomorphically encrypted dummy pattern 3D data using the second encryption key, which has been used for homomorphically encrypting the dummy pattern 3D data, and remove the dummy pattern 3D data from the decrypted 3D data to regenerate the 3D data more accurately.

By adding such dummy pattern 3D data, it is possible to achieve more security and confidentiality in terms of performing 3D printing in the medical/bio sector in which 3D body shape data that is sensitive personal information is used. In other words, by adding dummy pattern 3D data, multi-level data security protection can be provided.

Meanwhile, FIG. 1 shows an example in which the 3D data generation device 100 and the analysis server 200 are physically separated, but the 3D data generation device 100 and the analysis server 200 may be integrated as one device. In this case, the 3D data generation device 100 may be included in the analysis server 200, or conversely the analysis server 200 may be included in the 3D data generation device 100. In addition, FIG. 1 shows an example in which the 3D data generation device 100 and the 3D printing device 300 are physically separated, but the 3D data generation device 100 and the 3D printing device 300 may be integrated as one device.

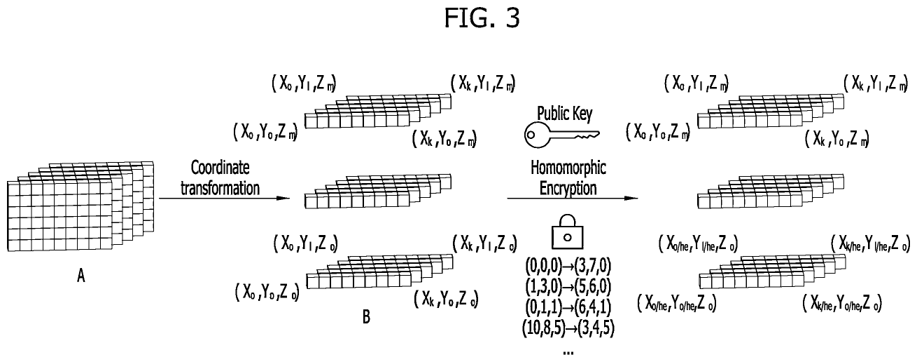

FIG. 2 is a schematic block diagram of a 3D data generation device according to an exemplary embodiment of the present invention, and FIG. 3 is an exemplary diagram illustrating a method of encrypting 3D data according to an exemplary embodiment of the present invention.

Referring to FIG. 2, the 3D data generation device 100 according to an exemplary embodiment of the present invention includes a communication module 110, a memory 120, a scan module 130, and a processor 140.

The communication module 110 in linkage with a communication network may provide an interface required for providing signals transmitted and received in the form of packet data between the 3D data generation device 100 and the analysis server 200. In particular, the communication module 110 may transmit and receive diverse information such as homomorphically encrypted 3D data and the like. In addition, the communication module 110 may be a device including hardware and software required for transmitting and receiving signals, such as a control signal and a data signal, to and from another network device via a wired or wireless connection. Moreover, the communication module 110 may be implemented in various forms, such as a short-range communication module, a wireless communication module, a mobile communication module, a wired communication module, and the like.

The memory 120 is a component that stores data related to operations of the 3D data generation device 100. Particularly, an application (program or applet) and the like to enable encryption of 3D data generated by scanning an object using a homomorphic encryption scheme may be stored in the memory 120, and the stored information may be selected by the processor 140 as necessary. That is, an operating system (OS) for operating the 3D data generation device 100 or several types of data generated in the execution process of the application (program or applet) are stored in the memory 120. Here, the memory 120 collectively refers to non-volatile storage devices that continuously retain stored information even when power is not supplied and volatile storage devices that require power to retain stored information.

The scan module 130 may move up and down or rotate with respect to an object, scan the top, bottom, left, right, interior, and the like of the object, and transmit information on the scanned object to the processor 140. In this case, the scan module 130 may include at least one of a laser-based scan sensor, a pattern light-based scan sensor, an infrared-based depth sensor, an image capture sensor, and a computed tomography (CT) scan sensor, and scan sensors may operate independently or in conjunction with each other depending on the size, material, and use of the scanned object.

For example, in the case that the object has a simple shape and does not have an internal function, or it is unnecessary to reconstruct the interior of the object, the object may be scanned using at least one external scan sensor among a laser-based scan sensor, a pattern light-based scan sensor, an infrared-based depth sensor, and an image capture sensor. On the other hand, in the case that the object has an internal function, or the interior of the object has a complex shape, the exterior of the object may be scanned using the aforementioned external scan sensor, and the interior of the object may be scanned using an internal scan sensor such as a CT scan sensor.

In this embodiment, the processor 140 is a subject that generates homomorphically encrypted 3D data and may be implemented as a central processing unit (CPU) or a system on chip (SoC). The processor 140 may run the OS or application to control a plurality of hardware or software components connected to the processor 140 and perform various types of data processing and computation. The processor 140 may be configured to execute at least one instruction stored in the memory 120 and store the execution result data in the memory 120.

The processor 140 may generate 3D graphic data (hereinafter “3D data”) of the object scanned by the scan module 130 and encrypt the generated 3D data in accordance with the homomorphic encryption scheme.

An operation of the processor 140 encrypting 3D data will be described in detail below.

The processor 140 may generate the 3D data of the object scanned by the scan module 130 and generate a first encryption key. Here, the first encryption key may include a public key and a private key.

Subsequently, the processor 140 may encrypt the 3D data in accordance with homomorphic technology using the first encryption key. At this time, the processor 140 may encrypt the 3D data using the first encryption key in accordance with an algorithm defined in the homomorphic encryption scheme. Here, the homomorphic encryption scheme may be any of various schemes, such as a BGV scheme, a BFV scheme, a CKKS scheme, and the like.

In the process of encrypting the 3D data, most 3D data are coordinates in the form of real numbers (including decimals). Accordingly, it is advantageous for use in the optimization process based on AI and machine learning to utilize a homomorphic encryption scheme to which real numbers are applicable rather than a method in which only integers are utilized. Therefore, the processor 140 may encrypt the 3D data using a homomorphic encryption scheme to which real numbers are applicable. For example, the processor 140 may encrypt the 3D data using the CKKS scheme.

Further, the processor 140 may slice the 3D data into a plurality of layers and encrypt coordinate data of each layer with respect to a reference axis using the homomorphic encryption scheme. In other words, the processor 140 may divide the 3D data into layers to allow 3D printing. After that, the processor 140 may apply homomorphic encryption to each layer sliced with respect to the reference axis. At this time, the processor 140 may apply homomorphic encryption by performing a separate encryption process for each layer with respect to the reference axis and separately setting an interface reference for each layer.

For example, a method of encrypting the coordinate data of each layer will be described below with reference to FIG. 3. In this case, the processor 140 may slice 3D data such as A in a manner such as B. Subsequently, the processor 140 may perform homomorphic encryption by fixing a value of a reference axis and converting a value of another axis. For example, when a z-axis is the reference axis, the processor 140 may perform encryption by fixing the z-axis to “0” within the coordinate data of each layer and converting only an x-axis and a y-axis. As an example, (0, 0, 0) may be encrypted into (3, 7, 0), and (1, 3, 0) may be encrypted into (5, 6, 0).

In this way, the processor 140 may encrypt coordinate data of each sliced layer to be converted into other coordinates.

The processor 140 may transmit the homomorphically encrypted 3D data to the analysis server 200 via the communication module 110. At this time, the processor 140 may generate encryption scheme information to notify the analysis server 200 which homomorphic encryption scheme the homomorphically encrypted 3D data that has been encrypted is based on and transmit the generated encryption scheme information to the analysis server 200 via the communication module 110.

Meanwhile, according to another exemplary embodiment of the present invention, the 3D data generation device 100 may operate as the 3D printing device 300. In this case, the 3D data generation device 100 may further include an output module (not shown) that outputs 3D data. The processor 140 may receive homomorphically encrypted result data from the analysis server 200 via the communication module 110, generate 3D data and optimized 3D printing control information by decrypting the homomorphically encrypted result data, and three-dimensionally print the decrypted 3D data through the output module on the basis of the optimized 3D printing control information. Here, the 3D printing device 300 may decrypt the homomorphically encrypted result data using a first encryption key used for encrypting the 3D data.

FIG. 4 is a schematic block diagram of an analysis server according to an exemplary embodiment of the present invention.

Referring to FIG. 4, the analysis server 200 according to an exemplary embodiment of the present invention includes a server communication module 210, a server memory 220, and a server processor 230.

The server communication module 210 in linkage with a communication network may provide an interface required for providing signals transmitted and received in the form of packet data between the analysis server 200 and the 3D data generation device 100 or between the analysis server and the 3D printing device 300. In particular, the server communication module 210 may transmit and receive diverse information such as homomorphically encrypted 3D data, homomorphically encrypted result data, and the like. In addition, the server communication module 210 may be a device including hardware and software required for transmitting and receiving signals, such as a control signal and a data signal, to and from another network device via a wired or wireless connection. In addition, the server communication module 210 may be implemented in various forms such as a short-range communication module, a wireless communication module, a mobile communication module, a wired communication module, and the like.

The server memory 220 is a component that stores data related to operations of the analysis server 200. Particularly, an application (program or applet) and the like that allows generation of homomorphically encrypted result data by performing homomorphic operation on homomorphically encrypted 3D data may be stored in the server memory 220, and the stored information may be selected by the server processor 230 as necessary. In other words, an OS for operating the analysis server 200 or several types of data generated in the execution process of the application (program or applet) are stored in the server memory 220. At this time, the server memory 220 generally refers to a non-volatile storage device that continuously retains stored information even when power is not supplied and a volatile storage device that requires power to retain stored information.

The server processor 230 may be implemented as a CPU or an SoC. The server processor 230 may run the OS or application to control a plurality of hardware or software components connected to the server processor 230 and perform various types of data processing and computation. The server processor 230 may be configured to execute at least one instruction stored in the server memory 220 and store the execution result data in the server memory 220.

The server processor 230 may perform a homomorphic operation on the homomorphically encrypted 3D data to generate homomorphically encrypted result data including optimized 3D printing control information to be applied to 3D printing and may transmit the generated homomorphically encrypted result data to the 3D printing device 300 via the server communication module 210.

Operations of the server processor 230 will be described in detail below.

The server processor 230 may receive the homomorphically encrypted 3D data from the 3D data generation device 100 via the server communication module 210. At this time, the server processor 230 may also receive the encryption scheme information together with the 3D data.

The server processor 230 may determine the encryption scheme of the homomorphically encrypted 3D data on the basis of the encryption scheme information and perform homomorphic operations on the homomorphically encrypted 3D data in an encrypted state in accordance with the determined encryption scheme. At this time, the server processor 230 may perform various homomorphic operations such as a homomorphic multiplication operation, a modular operation, a re-linearization operation, a key switching operation, a modulus switching operation, and the like.

The server processor 230 may perform multiple homomorphic operations on the homomorphically encrypted 3D data to generate homomorphically encrypted result data. Here, the homomorphically encrypted result data may include the homomorphically encrypted 3D data, the optimized 3D printing control information, the homomorphically encrypted dummy pattern 3D data, and the like.

Specifically, the server processor 230 may select 3D printing control information including at least one of a 3D printing process method, a 3D printing material, a 3D printing material property, a 3D printing cost, and a 3D printing path of the 3D data by performing a homomorphic operation on the homomorphically encrypted 3D data. Here, during the homomorphic operation of the homomorphically encrypted 3D data, the server processor 230 may remove defective data by optimizing the homomorphically encrypted 3D data and select 3D printing control information on the basis of the homomorphically encrypted 3D data from which defective data has been removed. Subsequently, the server processor 230 may perform simulation on the 3D data on the basis of the selected 3D printing control information and predict, on the basis of the simulation results, quality performance when the 3D data is applied to 3D printing. The server processor 230 may optimize the 3D printing control information on the basis of the predicted quality performance. For example, the server processor 230 may optimize the 3D printing control information by reselecting 3D printing condition information until the predicted quality performance satisfies quality requested by a user. In other words, the server processor 230 may optimize the 3D printing control information, such as the 3D printing process method, the 3D printing material, the 3D printing material property, the 3D printing cost, the 3D printing path, and the like of the 3D data. After that, the server processor 230 may transmit the homomorphically encrypted result data including the optimized 3D printing control information and the homomorphically encrypted 3D data to the 3D printing device 300 via the server communication module 210.

In this way, the server processor 230 can select a printing material, a printing material quality, and the like appropriate for 3D data characteristics and perform optimization for selecting a printing method and a printer for performing printing in accordance with the selected printing material, the printing material quality, and the like. In addition, the server processor 230 can ensure optimized quality by optimizing the 3D data using personal information or sensitive information in an external or cloud environment and applying the 3D data to 3D printing.

The server processor 230 may employ one or more hardware accelerators when performing the homomorphic operation of the homomorphically encrypted 3D data. In other words, the server processor 230 may include a hardware accelerator that has a function frequently utilized in computation when 3D data is homomorphically encrypted to increase computation speed.

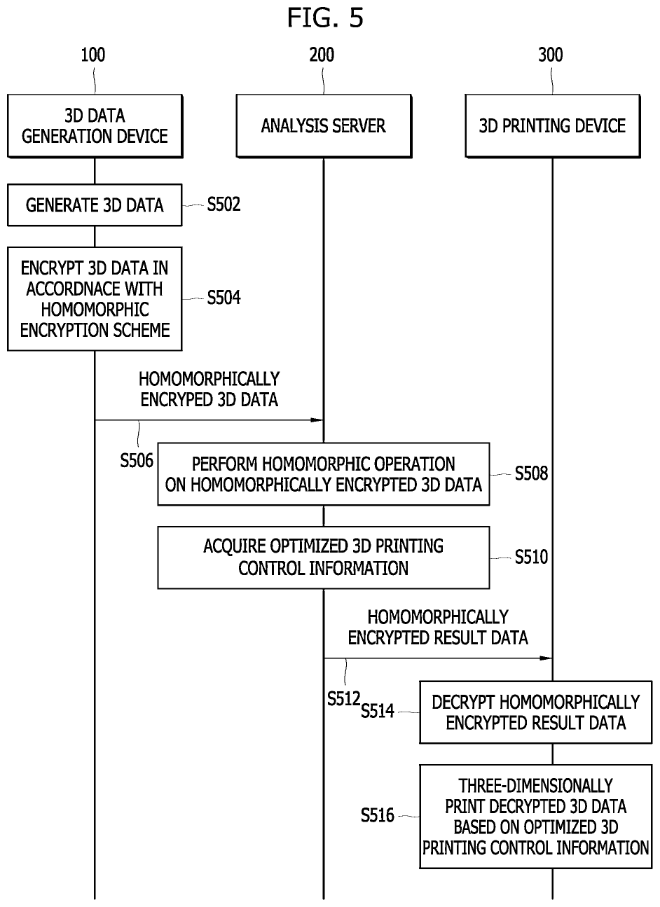

FIG. 5 is a sequence diagram illustrating a 3D printing method employing homomorphic encryption according to an exemplary embodiment of the present invention.

Referring to FIG. 5, the 3D data generation device 100 generates 3D data by scanning an object (S502), encrypts the generated 3D data using a homomorphic encryption scheme (S504), and transmits the homomorphically encrypted 3D data to the analysis server 200 (S506). At this time, the 3D data generation device 100 may generate a first encryption key and encrypt the 3D data using the first encryption key in accordance with an algorithm defined in the homomorphic encryption scheme.

When operation S506 is performed, the analysis server 200 performs a homomorphic operation on the homomorphically encrypted 3D data (S508) and acquires optimized 3D printing control information (S510). In other words, the analysis server 200 may select 3D printing control information including at least one of a 3D printing process method, a 3D printing material, a 3D printing material property, a 3D printing cost, and a 3D printing path of the 3D data by performing a homomorphic operation on the homomorphically encrypted 3D data. Subsequently, the analysis server 200 may perform simulation on the 3D data on the basis of the selected 3D printing control information and predict on the basis of the simulation results, quality performance when the 3D data is applied to 3D printing. After that, the analysis server 200 may optimize the 3D printing control information on the basis of the quality performance that has been predicted.

When operation S510 is performed, the analysis server 200 transmits homomorphically encrypted result data including the optimized 3D printing control information and the homomorphically encrypted 3D data to the 3D printing device 300 (S512).

When operation 512 is performed, the 3D printing device 300 generates the 3D data and the optimized 3D printing control information by decrypting the homomorphically encrypted result data (S514) and three-dimensionally prints the decrypted 3D data on the basis of the optimized 3D printing control information (S516). At this time, the 3D printing device 300 may decrypt the homomorphically encrypted result data using the first encryption key used for encrypting the 3D data. The 3D printing device 300 can output a 3D object in the same shape as or a complemented shape of the initially scanned object in accordance with the optimized 3D printing control information (a 3D printing process method, a 3D printing material, a 3D printing material property, a 3D printing cost, and a 3D printing path).

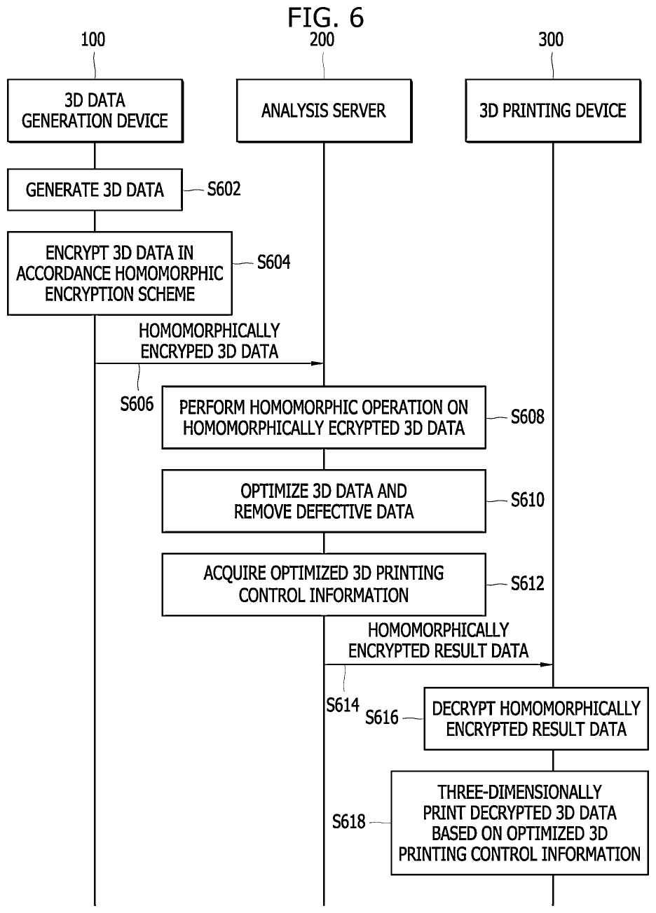

FIG. 6 is a sequence diagram illustrating a 3D printing method employing homomorphic encryption according to another exemplary embodiment of the present invention.

Referring to FIG. 6, the 3D data generation device 100 generates 3D data by scanning an object (S602), encrypts the generated 3D data using a homomorphic encryption scheme (S604), and transmits the homomorphically encrypted 3D data to the analysis server 200 (S606). Here, the 3D data generation device 100 may generate a first encryption key and encrypt the 3D data using the first encryption key in accordance with an algorithm defined in the homomorphic encryption scheme.

When operation S606 is performed, the analysis server 200 performs a homomorphic operation on the homomorphically encrypted 3D data (S608), optimizes the 3D data, and removes defective data (S610).

When 3D data of an external or internal body organ shape among 3D data to which homomorphic encryption has been applied is utilized, the original data obtained by scanning requires additional modeling due to errors and the like that arise in the scanning process. Accordingly, the analysis server 200 may optimize the 3D data and selectively remove defective data from the optimized 3D data. Depending on a selection of a user, operation S610 may also be performed before the 3D data generation device 100 encrypts the 3D data.

When operation S610 is performed, the analysis server 200 acquires optimized 3D printing control information on the basis of the 3D data from which defective data has been removed (S612).

Since the process subsequent to the operation S612 is the same as the process of FIG. 5 subsequent to operation S510, a detailed description thereof will be omitted.

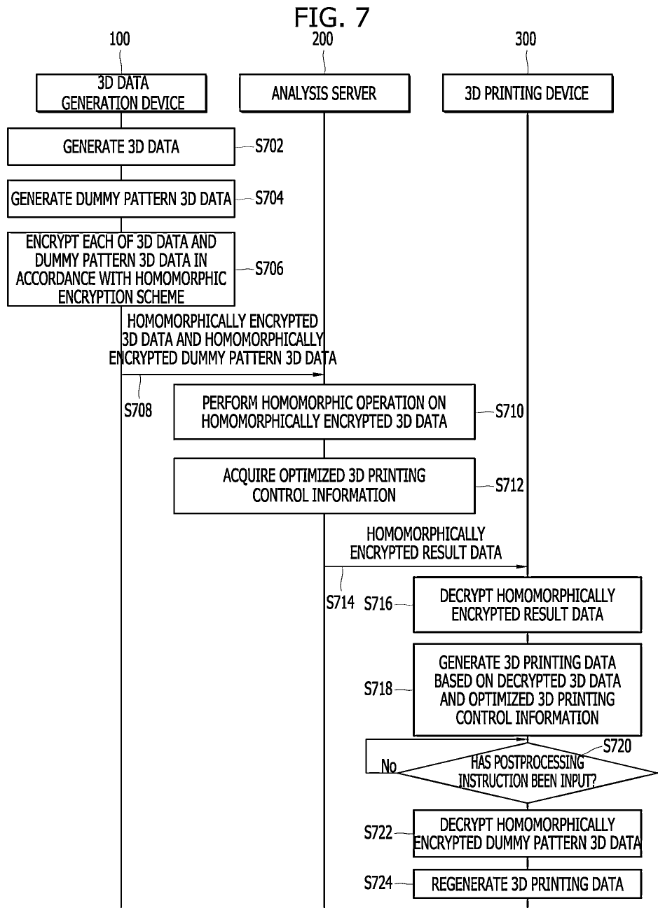

FIG. 7 is a sequence diagram illustrating a 3D printing method employing homomorphic encryption according to still another exemplary embodiment of the present invention.

Referring to FIG. 7, the 3D data generation device 100 generates 3D data by scanning an object (S702) and generates dummy pattern 3D data (S704).

When operation S704 is performed, the 3D data generation device 100 encrypts the 3D data in accordance with a homomorphic encryption scheme using a first encryption key and encrypts the dummy pattern 3D data in accordance with the homomorphic encryption scheme using a second encryption key (S706).

When operation S706 is performed, the 3D data generation device 100 transmits the homomorphically encrypted 3D data and homomorphically encrypted dummy pattern 3D data to the analysis server (S708).

When operation S708 is performed, the analysis server 200 performs a homomorphic operation on the homomorphically encrypted 3D data (S710) and acquires optimized 3D printing control information (S712).

When operation S712 is performed, the analysis server 200 transmits homomorphically encrypted result data including the optimized 3D printing control information, the homomorphically encrypted 3D data, and the homomorphically encrypted dummy pattern 3D data to the 3D printing device 300 (S714).

When operation S714 is performed, the 3D printing device 300 generates the 3D data and the optimized 3D printing control information by decrypting the homomorphically encrypted result data using the first encryption key (S716) and generates 3D printing data on the basis of the decrypted 3D data and the optimized 3D printing control information (S718). At this time, the homomorphically encrypted dummy pattern 3D data may not be in a decrypted state. The generated 3D printing data may be output through the 3D printing device 300.

When operation S718 is performed, the 3D printing device 300 determines whether a postprocessing command has been input (S720).

When it is determined in operation S720 that a postprocessing command has been input, the 3D printing device 300 decrypts the homomorphically encrypted dummy pattern 3D data using the second encryption key (S722) and regenerates the 3D printing data by removing the decrypted dummy pattern 3D data from the 3D printing data generated in operation S718 (S724). The regenerated 3D printing data may be output through the 3D printing device 300.

By adding the dummy pattern 3D data in this way, it is possible to achieve more security and confidentiality in terms of performing 3D printing in the medical/bio sector in which 3D body shape data that is sensitive personal information is used. In other words, the dummy pattern 3D data is added to protect multi-level data security.

According to an aspect of the present invention, 3D data including sensitive personal data of a health/medical field, a healthcare field, or the like and classified data of advanced manufacturing industries, such as semiconductor, display, battery, sensor, and automobile industries, and the like and space and defense industries requiring highly reliable security and the like is homomorphically encrypted, and an optimization process via AI, machine learning, or the like is securely performed on the homomorphically encrypted 3D data in an external entity or a cloud environment. Accordingly, it is possible to have the effect of increasing security and reliability when three-dimensionally printing 3D data such as personal data, classified data, or the like.

Although the present invention has been described above with reference to embodiments illustrated in the drawings, the embodiments are merely illustrative, and those skilled in the art should understand that various modifications and other equivalent embodiments can be made from the embodiments.

Therefore, the technical scope of the present invention should be determined from the following claims.

What is claimed is:

1. A three-dimensional (3D) data generation device, comprising:
a memory;
a scan module; and
a processor connected to the memory and the scan module,
wherein the processor generates 3D data of an object scanned through the scan module and encrypts the 3D data in accordance with a homomorphic encryption scheme.

2. The 3D data generation device of claim 1, wherein the processor generates a first encryption key and encrypts the 3D data using the first encryption key in accordance with an algorithm defined in the homomorphic encryption scheme.

3. The 3D data generation device of claim 1, wherein the processor slices the 3D data into a plurality of layers and encrypts coordinate data of each layer with respect to a reference axis in accordance with the homomorphic encryption scheme.

4. The 3D data generation device of claim 1, further comprising an output module,
wherein the processor receives homomorphically encrypted result data from an analysis server, generates the 3D data and optimized 3D printing control information by decrypting the homomorphically encrypted result data, and three-dimensionally prints the decrypted 3D data through the output module in accordance with the optimized 3D printing control information.

5. The 3D data generation device of claim 4, wherein the processor decrypts the homomorphically encrypted result data using a first encryption key used for encrypting the 3D data.

6. The 3D data generation device of claim 1, wherein the processor generates dummy pattern 3D data, encrypts the dummy pattern 3D data in accordance with the homomorphic encryption scheme using a second encryption key, and transmits the homomorphically encrypted dummy pattern 3D data together with the homomorphically encrypted 3D data to an analysis server.

7. The 3D data generation device of claim 6, wherein, when homomorphically encrypted result data including the homomorphically encrypted 3D data, the homomorphically encrypted dummy pattern 3D data, and optimized 3D printing control information is received from the analysis server, the processor decrypts the 3D data and the optimized 3D printing control information by decrypting the homomorphically encrypted result data using a first encryption key used for homomorphically encrypting the 3D data and decrypts the dummy pattern 3D data by decrypting the homomorphically encrypted dummy pattern 3D data using the second encryption key.

8. An analysis server, comprising:
a server communication module;
a server memory; and
a server processor connected to the server communication module and the server memory,
wherein the server processor receives homomorphically encrypted three-dimensional (3D) data from a 3D data generation device through the server communication module, acquires optimized 3D printing control information by performing a homomorphic operation on the homomorphically encrypted 3D data, and generates homomorphically encrypted result data including the optimized 3D printing control information.

9. The analysis server of claim 8, wherein the server processor selects the optimized 3D printing control information including at least one of a 3D printing process method, a 3D printing material, a 3D printing material property, a 3D printing cost, and a 3D printing path on the basis of the homomorphically encrypted 3D data, performs simulation on the 3D data on the basis of the selected optimized 3D printing control information, and predicts quality performance when the 3D data is applied to 3D printing.

10. The analysis server of claim 8, wherein the server processor optimizes the homomorphically encrypted 3D data and removes defective data during the homomorphic operation of the homomorphically encrypted 3D data.

11. The analysis server of claim 8, wherein the server processor employs one or more hardware accelerators during the homomorphic operation of the homomorphically encrypted 3D data.

12. A three-dimensional (3D) printing method employing homomorphic encryption, the 3D printing method comprising:
encrypting, by a 3D data generation device, 3D data generated by scanning an object in accordance with a homomorphic encryption scheme, and transmitting the homomorphically encrypted 3D data to an analysis server;
performing, by the analysis server, a homomorphic operation on the homomorphically encrypted 3D data to acquire optimized 3D printing control information and transmitting homomorphically encrypted result data including the optimized 3D printing control information to a 3D printing device; and
decrypting, by the 3D printing device, the homomorphically encrypted result data to generate the 3D data and the optimized 3D printing control information and three-dimensionally printing the decrypted 3D data on the basis of the optimized 3D printing control information.

13. The 3D printing method of claim 12, wherein the transmitting the homomorphically encrypted 3D data to the analysis server comprises generating, by the 3D data generation device, a first encryption key and encrypting the 3D data in accordance with an algorithm defined in the homomorphic encryption scheme using the first encryption key.

14. The 3D printing method of claim 12, wherein the transmitting of the homomorphically encrypted 3D data to the analysis server comprises slicing, by the 3D data generation device, the 3D data into a plurality of layers and encrypting coordinate data of each layer with respect to a reference axis in accordance with the homomorphic encryption scheme.

15. The 3D printing method of claim 12, wherein the transmitting of the homomorphically encrypted 3D data to the analysis server comprises selecting, by the analysis server, the optimized 3D printing control information including at least one of a 3D printing process method, a 3D printing material, a 3D printing material property, a 3D printing cost, and a 3D printing path on the basis of the homomorphically encrypted 3D data, and performing simulation on the 3D data on the basis of the selected optimized 3D printing control information to predict quality performance when the 3D data is applied to 3D printing.

16. The 3D printing method of claim 12, wherein the transmitting of the homomorphically encrypted result data to the analysis server comprises performing, by the analysis server, a homomorphic operation on the homomorphically encrypted 3D data to optimize the 3D data and remove defective data, and then acquiring the optimized 3D printing control information.

17. The 3D printing method of claim 12, wherein the 3D printing of the decrypted 3D data comprises decrypting, by the 3D printing device, the homomorphically encrypted result data using a first encryption key used for encrypting the 3D data.

18. The 3D printing method of claim 12, wherein the transmitting of the homomorphically encrypted 3D data to the analysis server comprises generating, by the 3D data generation device, dummy pattern 3D data, encrypting the dummy pattern 3D data in accordance with the homomorphic encryption scheme using a second encryption key, and transmitting the homomorphically encrypted dummy pattern 3D data together with the homomorphically encrypted 3D data to the analysis server.

19. The 3D printing method of claim 18, wherein the 3D printing of the decrypted 3D data comprises:
when the homomorphically encrypted result data includes the homomorphically encrypted 3D data, the homomorphically encrypted dummy pattern 3D data, and the optimized 3D printing control information, decrypting, by the 3D printing device, the homomorphically encrypted result data using a first encryption key used for homomorphically encrypting the 3D data to decrypt the 3D data and the optimized 3D printing control information; and
decrypting the homomorphically encrypted dummy pattern 3D data using the second encryption key to decrypt the homomorphically encrypted dummy pattern 3D data.

20. The 3D printing method of claim 19, wherein the 3DI printing of the decrypted 3D data comprises removing, by the 3D printing device, the decrypted dummy pattern 3D data from the decrypted 3D data to regenerate the 3D data and three-dimensionally printing the regenerated 3D data on the basis of the optimized 3D printing control information.
